(19) United States
(12) Patent Application Publication
(10) Pub. No.: US 2022/0343143 A1
(43) Pub. Date: Oct. 27, 2022

(54) METHOD FOR GENERATING AN ADAPTED TASK GRAPH

(71) Applicant: SIEMENS AKTIENGESELLSCHAFT, München (DE)

(72) Inventors: Stephan Grimm, München (DE); Marcel Hildebrandt, München (DE); Mitchell Joblin, München (DE); Martin Ringsquandl, Raubling (DE)

(21) Appl. No.: 17/641,899

(22) PCT Filed: Sep. 10, 2020
(86) PCT No.: PCT/EP2020/075261

§ 371 Date: Mar. 10, 2022

(30) Foreign Application Priority Data
Sep. 11, 2019 (EP) 19196755.3

(51) Int. Cl. G06N 3/04; G06N 3/08

(52) U.S. Cl. CPC G06N 3/0472; G06N 3/0481; G06N 3/08

(57) ABSTRACT

A computer-implemented method for generating an adapted task graph, including the steps of providing a first input data set with at least one task graph and at least one task context and/or a second input data set with at least one constraint and at least one task context, generating an adapted task graph using a trained neural network based on the first input data set and/or the second input data set, and providing the adapted task graph.

### CROSS REFERENCE TO RELATED APPLICATIONS

This present patent document is a § 371 nationalization of PCT Application Serial Number PCT/EP2020/075261 filed Sep. 10, 2020, designating the United States, which is hereby incorporated in its entirety by reference. This patent document also claims the benefit of EP19196755.3 filed on Sep. 11, 2019, which is also hereby incorporated in its entirety by reference.

### FIELD

Embodiments relate to a computer-implemented method for generating an adapted task graph.

### BACKGROUND

Complex industrial plants may include distinct parts, modules, or units with a multiplicity of individual functions. Exemplary units include sensors and actuators. Each unit has to fulfill or meet one or more certain functions. Thereby, the functions may be equally referred to as tasks or operations in the following. Process planning plays an important role to formally describe and analyze the complex industrial processes.

Task graphs may be used for process planning. Example task graphs are depicted in FIG. 2. The task graphs include a sequence of operations and their dependencies. More specifically, the task graph is a graph with N nodes and respective edges. The nodes are operations, and the edges are the input-output dependencies between the operations. Each operation may have multiple predecessors and successors. The graphs may be modeled using precedence diagram methods. The diagrams are defined as directed acyclic graphs. The nodes are the operations and the edges between the nodes specify their sequential or topological ordering.

Computer-aided process planning (“CAPP”) is known for storage, creation, retrieval, and modification of process plans and references to products, parts, and machines. The process plans may be semi-automatically generated when there is a clear manually defined relationship between the machine operations and the design features in the computer-aided design (“CAD”) drawing.

However, these relationships may be hardly defined and are often not available. Thus, the availability of the relationships is insufficient. In this case, the experts have to manually go through documentations of existing process plans and communicate with the product engineers to find similarities. This often requires inefficient visual inspection of the technical drawings.

The disadvantage of the manual approach is that it relies on domain expertise and thus expert knowledge. The manual approach is cost intensive, time-consuming and error prone.

For example, “NetGAN: Generating Graphs via Random Walks” (Aleksandar Bojchevski et al.: 11, ARXIV.org, CORNELL UNIVERSITY LIBRARY, 201 OLIN LIBRARY CORNELL UNIVERSITY ITHACA, N.Y. 14853) describes the generation of graphs but the method cannot generalize from multiple graphs to novel ones but may only re-generate the same (one) graph it has received as an input, with some minor variance. Moreover, it cannot be considered as an “anytime” algorithm, i.e., inference may not be done from any partial graph as starting point and such method may not be conditioned on an existing partial graph as input. Lastly, the described method cannot use arbitrary objective functions to generate the graphs. Instead, it has only a maximum likelihood objective for the random walks.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Embodiments provide a computer-implemented method for generating an adapted task graph in an efficient and reliable manner.

Embodiments provide a computer-implemented method for generating an adapted task graph, including the steps of providing a first input data set with at least one initial task graph and at least one task context and/or a second input data set with at least one constraint and at least one task context, wherein the task context is information that is required to design the task graph in such a manner that the task graph delivers a desired output, wherein such output is the adapted task graph, that may be used to generate a product, generating an adapted task graph using a trained neural network based on the first input data set and/or the second input data set, for example using a reinforcement learning-based approach based on distinct input data sets, and providing the adapted task graph.

As indicated above, collecting all possible dependencies and declaring them in a rule-based fashion is a major challenge, since dependencies between operations are typically conditioned on the task context. Such context constitutes the requirements that the whole task should achieve, i.e., the desired qualities that the final output needs to have. For example, in case a wooden work piece should be painted in white color, an additional priming operation is needed before painting. Such additional task context drives the operations needed and their dependencies and it is, therefore, an essential part of the method proposed herein.

Accordingly, embodiments include a computer-implemented method for generating an adapted task graph. In other words, incomplete or partial task graphs as initial task graphs from empty to almost complete are adapted. For example, one or more nodes or edges may be added to the initial task graph or removed from the initial task graph. Thus, the adaptation includes extension and deletion.

An operation is a single activity, task or function, defining e.g., what is the output i.e., product part, all necessary inputs i.e., other product parts, raw material, the type of operation i.e. how input should be processed, transforming or assembling the inputs into the output, which tools to use i.e. machines, and/or how long it should take i.e. processing time.

In a first step at least one input data set is received. The first and second input data sets are different.

The first input data set includes the initial task graph and at least one task context. The task context is information that is required to design the task graph in such a manner that the task graph delivers the desired output. The output is the adapted task graph, that may be used to generate the product. The task context may include drawings of the product to be produced e.g., CAD, software diagrams and architectural drawings, bill of materials, structured text requirements, unstructured text requirements, specification of hard constraints, soft constraints of operation dependencies e.g., existing rules, best practices.

The second input data set includes at least one constraint and at least one task context. The constraints are e.g., hard constraints and/or soft constraints, e.g., physical dependencies, time restrictions, resource restrictions, existing rules, best practices.

In a next step the adapted task graph is determined using a trained neural network based on the first input data set and/or the second input data set. Thus, the distinct input data sets may be processed by one common trained neural network.

Therefore, a trained machine learning model is applied using machine learning during throughput.

To the contrary, in the training phase, a set of independent input data sets is used as training data set to train the machine learning model. The machine learning model is a graph convolutional network in an embodiment.

Thus, in other words, the machine learning model is untrained and used in the training process with a training input data set, whereas the trained machine learning model is used after training in the running system or for the method.

The method provides an improved efficiency and accuracy in determining the adapted task graph. The adapted task graph and in the end the product is more reliable compared to prior art.

Considering autonomous driving and autonomous cars as final product solutions, the safety of the operator and car may be significantly increased. Accidents may be prevented from the very beginning taking the operator's needs into account. For example, the generated task graph may be used to generate the autonomous car taking the customer's needs into account. Another example is directed to the incorporation of the generated task graph into the algorithm or software of the autonomous car.

More precisely, the advantage is that the method enables the complementation or completion of task graphs in an efficient and reliable manner. The disadvantages of the expensive and time-consuming specification of task graphs solely based on expert knowledge and market research according to prior art may be overcome.

Applications may include bill of process generation and Computational graph generation.

For Bill of Process Generation, production plants may have historical data about executed tasks on different machines, that together form a task graph. These task graphs are also called “Bill of Processes.” The method may be used for generating new Bill of Processes for new products. For example, a task graph may be generated that produces the given product with the smallest amount of resources needed.

For Computational Graph Generation, many software systems work on graph-based abstractions to schedule operations. For example, data processing pipelines are made more efficient when all the dependencies between operations are specified in such a manner that they may be executed in parallel. Given a data processing problem, the method may be used for generating a corresponding and optimal task graph with respect to an optimization factor e.g., achieve lowest processing time.

In one aspect the task graph is a typed task graph. The typed task graph (TTG) is a directed acyclic graph G=<V, E, L> where V is a set of operation nodes, E is a set of ordered pairs of nodes and 1:V->0 maps vertices to a finite set of operation types (labels). The cardinality of the set of vertices should cover all the operations with |V|=N. The typed task graph has proven to be advantageous in view of the dependencies between the operations and allows for flexibility.

The generation of the typed task graph may be modeled as an episodic Markov Decision Process, wherein trajectories are obtained from the Markov Decision Process wherein such a trajectory is a sequence of triples (<s1, a1, r1>, . . . , <st, at, rt>, . . . , <sT, aT, rT>) where s is a state, a is an action, r is a reward, each at time t until the end of an episode T. Therein, the reward may be given by how well the generated typed task graph matches existing or known examples of valid typed task graphs and/or by solving or minimizing a number of violated constraints.

In another aspect the neural network is a graph convolutional network. The graph convolutional network has proven to be advantageous since the network may gather structural information of the task graph and may handle a variable number of nodes.

The graph convolutional network iteratively takes a current state <TC, Gₜ> as input and such input is subsequently encoded into a continuous vector zₓ using a graph neural network and a process context encoder. The graph convolutional network employs two function approximators with a Softmax activation representing a factorized probability distribution over the action space Aₜ, wherein the first action distribution models the probability of picking a source node s for an extension of the current typed task graph and the second action distribution models a conditional probability of picking a target node t and therefore placing an edge between s and t to extend the current typed task graph. Then, s and t are sampled according to the output of the action distributions, resulting in a next state Gₜ₊₁.

In another aspect, the method includes the further steps of determining an evaluated adapted task graph, wherein the evaluation depends on the input data set, and providing the evaluated adapted task graph. Accordingly, the adapted task graph is evaluated before being provided. The evaluation provides that only reliable adapted task graphs are outputted and used for any subsequent applications.

In another aspect the evaluation includes the step of evaluating the adapted task graph by using a trained discriminator network based on the first input data set or evaluating the adapted task graph by checking the at least one constraint based on the second input data set.

The discriminator is a parameterized function d^{w}: G→Y, where Y={True, False}.

Therein, in an embodiment the function d^{w} may be linear and the discriminator is a logistic regression model p(y=True|G)=1/(1+e^{-w·xG}) where x_{G} is a feature representation of a typed task graph G and w is the linear model parameter vector.

The generator's policy model π^{θ} iteratively builds up typed task graphs Gₜ by sampling actions given states and gets a reward proportional to the likelihood of fooling the discriminator, wherein the network's objective function is to maximize an expected total reward by generating examples that are indistinguishable from actual examples for the discriminator.

In an embodiment a more complex discriminative model is used to effectively encode both task context and the task graph, wherein a graph convolutional network encoder is used, wherein, given a state <TC, Gₜ>, the graph convolutional network encoder constructs node embeddings that are condensed into a single vector using a graph pooling operation and concatenates the context embedding to the graph pooled one, resulting in zₓ. This combined vector representation of task context and graph is fed into a fully connected layer with a Sigmoid activation that models the probability of the pair being an actual example of a generated one.

Embodiments further provide a computer program product directly loadable into an internal memory of a computer, including software code portions for performing the steps according to the aforementioned method when the computer program product is running on a computer.

Embodiments further provide a generating unit for performing the aforementioned method.

The unit may be realized as any device, or any means, for computing, for example for executing a software, an app, or an algorithm. For example, the generating unit may include a central processing unit (CPU) and/or a memory operatively connected to the CPU. The unit may also include an array of CPUs, an array of graphical processing units (GPUs), at least one application-specific integrated circuit (ASIC), at least one field-programmable gate array, or any combination of the foregoing. The unit may include at least one module that in turn may include software and/or hardware. Some, or even all, modules of the units may be implemented by a cloud computing platform.

The approach proposed herein allows exploiting existing task graph examples to learn how to generalize dependencies between operations. The Graph Neural Network architecture allows to approximate infeasible computations such as maximum-common-subgraph and subgraph isomorphism. Moreover, the task graph generation agent may seamlessly be employed on any stage of incomplete/partial task graphs, from empty to almost complete, and a flexible agent objective function may incorporate similarity to existing examples, hard/soft constraints, or any additional reward assigned to a task graph. Finally, a stochastic agent policy may deliver different results on multiple playouts, giving more diverse recommendations to domain experts.

### BRIEF DESCRIPTION OF THE FIGURES

In the following detailed description, embodiments are further described with reference to the following figures:

FIG. 1 depicts a flowchart of the method according to an embodiment.

FIG. 2 depicts distinct exemplary task graphs according to an embodiment.

FIG. 3 depicts the graph convolutional policy network according to an embodiment.

FIG. 4 depicts the discriminator network according to an embodiment.

FIG. 5 depicts the training phase according to an embodiment.

### DETAILED DESCRIPTION

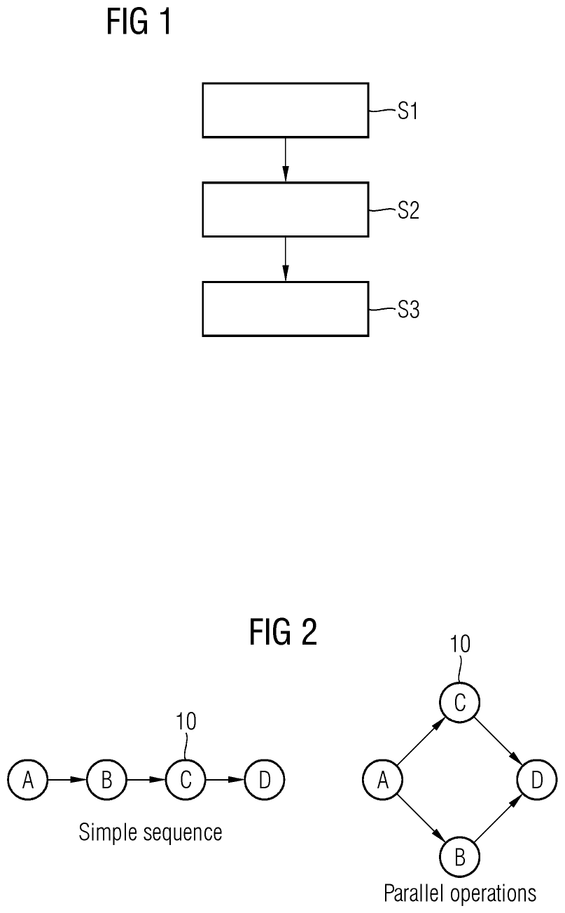

FIG. 1 depicts a flowchart of a method. The method for generating an adapted task graph 10 includes the following steps: providing a first input data set with at least one initial task graph 10 and at least one task context and/or a second input data set with at least one constraint and at least one task context S1, generating an adapted task graph 10 using a trained neural network based on the first input data set and/or the second input data set S2, and providing the adapted task graph 10, S3.

The adapted task graph 10 may be automatically generated using a reinforcement learning-based approach based on distinct input data sets. Thus, the method may be flexibly applied on distinct environments. Example task graphs 10 are depicted in FIG. 2 for illustration purposes.

The fact that reinforcement learning based artificial neural networks may be trained with arbitrary reward functions, in contrast to approaches applying supervised learning, the method proposed herein may use arbitrary objective functions to generate the graphs, e.g., checking constraints.

The method proposed herein is a reinforcement learning-based approach for the automated generation of typed task graphs (“TTG”), e.g., in three different environments as described below. The task graph generation as well as the completion is always conditioned on the actual task context as input. The goal is to learn to generalize also to unseen task context inputs and generate sensible TTGs.

The generation of a typed task graph (“TTG”) is modeled as an episodic Markov Decision Process (“MDP”) from which trajectories may be obtained. A trajectory or episode is a sequence of triples (<s₁, a₁, r₁>, . . . , <sₜ, aₜ, rₜ>, . . . , <s_{T}, a_{T}, r_{T}>) where s is a state, a is an action, r is a reward, at time t until the end of an episode T.

State space Sₜ is a tuple: <process context TC, the TTG at time t: Gₜ>

Action space Aₜ: {(i,j)|i,j∈Vₜ,(i,j)∉Eₜ}∪{(i,j′)|i∈Vₜ,j′∉Vt,l(j′)∈O}

The initial state is:

S₀=<PC, G₀>,

Where G₀ is the empty TTG or empty DAG.

This means that the agent may iteratively either add edges between existing operation nodes in the complete or partial process plan or add a new node j′ with a certain operation type.

Policy Learning:

The approach considers reinforcement learning to obtain a policy π^{θ}=P[a|s], that is a function parameterized by θ that defines a probability distribution over all possible actions in Aₜ given a state Sₜ.

Environments include Example based and constraint based. For Example, based:

Input: Database of pairs (context, task graph)

The reward is purely given by how well the generate TTG matches existing or known examples of valid TTGs.

Goal: Create a TTG that maximizes the similarity to existing TTGs given TC (Obj 1)

For Constraint-based

Input: Functions of hard and soft constraints F_{hard}: Sₜ→{True, False}, F_{soft}: Sₜ→

[symbol]

The reward is given by solving or minimizing the number of violated constraints.

Goal: Create a TTG that minimizes violated constraints given TC (Obj 2)

3) Combination of 1) and 2)

Input: triples of context, example task graphs, and constraints

Reward is a weighted combination of Obj 1 and Obj 2

Goal: Create a TTG that both maximizes similarity to existing TTCs by also minimizing violated constraints given TC

Other reward assignments may be plugged into the objective in all environments, i.e., any function that takes a task graph as input and assigns a value to it. For example, process simulation software may be used to evaluate the efficiency of a task graph.

The output in all cases is an agent with a policy π^{θ} conditioned on TC.

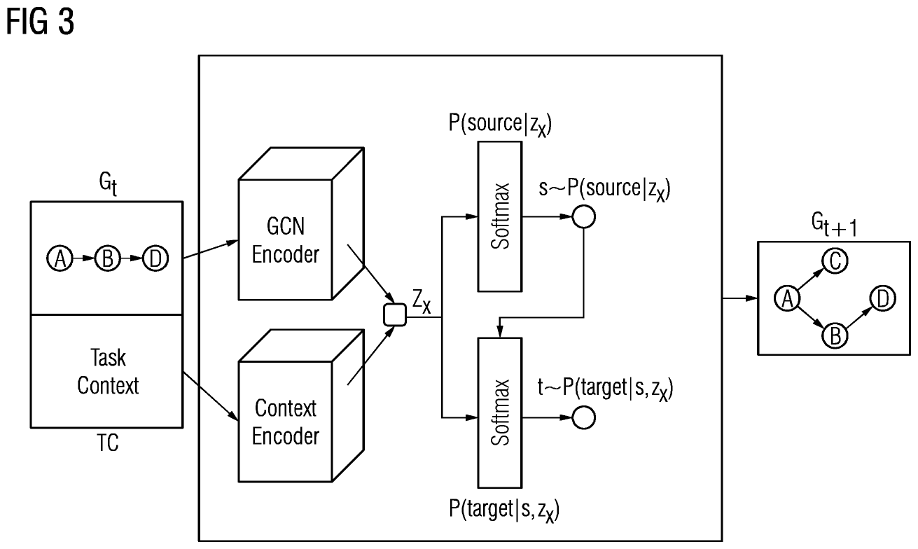

FIG. 3 depicts the graph convolutional network where an example set of operation types is given as O={A, B, C, D}. The graph convolutional network (GCN) iteratively takes the current state <TC, Gₜ> as input. This input is encoded into a continuous vector zₓ using some form of graph neural network e.g., graph convolutional network and a process context encoder, that may also be a graph convolutional network. The graph convolutional network further employs two function approximators with a Softmax activation representing a factorized probability distribution over the action space Aₜ. The first action distribution models the probability of picking the source node s for the extension of the current TTG. The second action distribution models the conditional probability of picking target node t and therefore placing an edge between s and t to extend the current TTG. As last step, s and t are sampled according to the output of the action distributions, resulting in the next state Gₜ₊₁.

The Markov features of the reinforcement learning approach as mentioned above in combination with the GCN state encoding allows to initiate the policy from an arbitrary state both in a training phase and for inference. Thus, the proposed method is an anytime algorithm, i.e., inference may be done from any partial graph as starting point.

Moreover, the proposed method is inductive, i.e., it may generalize from multiple graphs to novel ones. This is achieved because the actual state of a partial graph is encoded with the GCN and since node types may be applied as features the discriminator network described below may be trained for different graphs inductively.

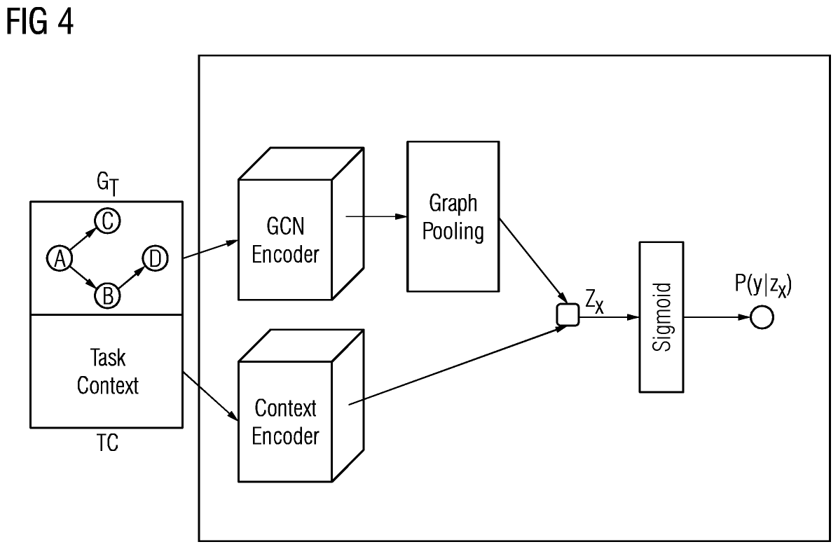

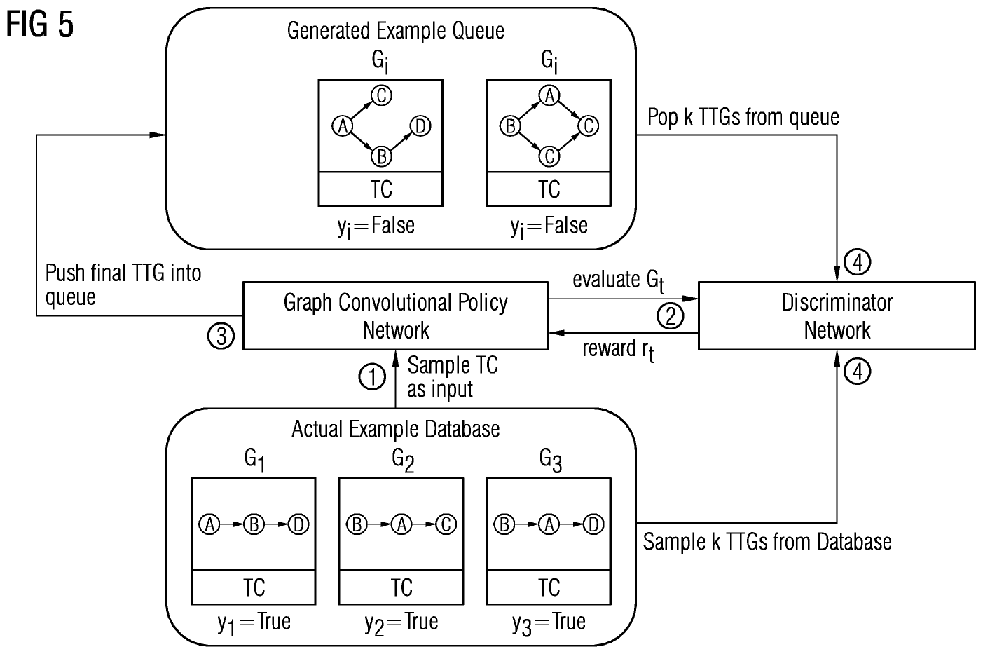

FIG. 4 depicts a discriminator network that may be trained in parallel to the graph convolutional network with the goal to learn how to discriminate generated process plans from real ones e.g., actual example database of process plans.

The discriminator is a parameterized function d^{w}: G→Y, where Y={True, False}. In case of a linear d^{w} the discriminator becomes a logistic regression model:

p(y=True|G)=1/(1+e^{-w·xG})

where x_{G} is some feature representation of a TTG G, and w is the linear model parameter vector.

Given a dataset of actual (True) and artificially generated (False) DAGs: {(x_{G1}, True), (x_{G2}, False), . . . } the discriminator model may be fitted to this data in a maximum-likelihood setting.

The generator's policy model π^{θ} iteratively builds up TTGs Gₜ by sampling actions given states and gets a reward proportional to the likelihood of fooling the discriminator, e.g., the final reward r_{T}≈p(y=True|G_{T}). The network's objective function is to maximize the expected total reward that means it has to generate examples that are indistinguishable from actual examples for the discriminator.

Instead of a linear model, a more complex discriminative model may be used to effectively encode both task context and the task graph. In an embodiment, a graph convolutional network encoder is used, since making the discriminator equally flexible as the network leads to better balancing during training. Given a pair of <TC, Gₜ> the encoder constructs node embeddings that are condensed into a single vector using a graph pooling operation e.g., sum, average, max and concatenates the context embedding to the graph pooled one, resulting in zₓ. This combined vector representation of task context and graph is then fed into a fully connected layer with a Sigmoid activation i.e., binary classifier that models the probability of this pair being an actual example of a generated one.

A training process is depicted in FIG. 5, according to which the training process includes the following steps: initializing the generation with a sampled task context from existing examples, iteratively growing and getting reward for the current TTG from the discriminator and adapting the policy, pushing the final TTG into an example queue, training the discriminator network on batches of k actual and k generated examples, and repeating the aforementioned steps until convergence of parameters.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A Computer-implemented method for generating an adapted task graph, the method comprising:
providing a first input data set with at least one initial task graph and at least one task context, wherein the at least one task context is information applyable to design a task graph in such a manner that the task graph delivers a desired output, wherein the desired output is the adapted task graph that is used to generate a product;
providing a second input data set with at least one constraint and at least one further task context,
generating the adapted task graph using a trained neural network based on the first input data set, the second input data set, or the first input data set and the second data set; and
providing the adapted task graph.

2. The Computer-implemented method of claim 1, wherein the task graph is a typed task graph.

3. The Computer-implemented method of claim 2, wherein the generation of a typed task graph is modeled as an episodic Markov Decision Process.

4. The Computer-implemented method of claim 3, wherein one or more trajectories are obtained from the episodic Markov Decision Process, wherein the one or more trajectories include a sequence of triples (<s1, a1, r1>, . . . , <st, at, rt>, . . . , <sT, aT, rT>) where s is a state, a is an action, r is a reward, each at time t until an end of an episode T.

5. The Computer-implemented method of claim 4, wherein the reward is given by how well the generated typed task graph matches existing or known examples of valid typed task graphs or by solving or minimizing a number of violated constraints.

6. The Computer-implemented method of claim 1, wherein the trained neural network is a graph convolutional network.

7. The Computer-implemented method of claim 6, wherein
the graph convolutional network iteratively takes a current state <TC, Gt> as input,
the input is encoded into a continuous vector zx using a graph neural network and a process context encoder,
the graph convolutional network employs two function approximators with a Softmax activation representing a factorized probability distribution over an action space At, wherein a first action distribution models the probability of picking a source node s for an extension of a current typed task graph and a second action distribution models a conditional probability of picking a target node t and therefore placing an edge between s and t to extend the current typed task graph, and
s and t are sampled according to the output of the action distributions, resulting in a next state Gt+1.

8. The Computer-implemented method of claim 1, further comprising:
determining an evaluated adapted task graph, wherein an evaluation of the adapted task graph depends on an input data set, and
providing the evaluated adapted task graph.

9. The Computer-implemented method of claim 8, wherein the evaluation comprises:
evaluating the adapted task graph by using a trained discriminator network based on the first input data set, or
evaluating the adapted task graph by checking the at least one constraint based on the second input data set.

10. The Computer-implemented method of claim 9, wherein the discriminator is a parameterized function dw: G→Y, where Y={True, False}.

11. The Computer-implemented method of claim 10, wherein the function dw is linear and the discriminator is a logistic regression model p(y=True|G)=1/(1+e−w·xG) where xG is a feature representation of a typed task graph G and w is a linear model parameter vector.

12. The Computer-implemented method of claim 11, wherein a generator's policy model πθ iteratively builds up typed task graphs Gt by sampling actions given states and gets a reward proportional to a likelihood of fooling the discriminator, wherein the network's objective function is to maximize an expected total reward by generating examples that are indistinguishable from actual examples for the discriminator.

13. The Computer-implemented method of claim 10, wherein a more complex discriminative model is used to encode both the task context and the task graph, wherein a graph convolutional network encoder is used, wherein, given a state <TC, Gt>,
the graph convolutional network encoder constructs node embeddings which are condensed into a single vector using a graph pooling operation and concatenates the context embedding to the graph pooled one, resulting in zx, and
wherein the combined vector representation of task context and graph is fed into a fully-connected layer with a Sigmoid activation that models a probability of the pair being an actual example of a generated one.

14. A computer program product directly loadable into an internal memory of a computer, comprising software code portions that when run on a computer are configured to:
provide a first input data set with at least one initial task graph and at least one task context, wherein the at least one task context is information applyable to design a task graph in such a manner that the task graph delivers an adapted task graph that is used to generate a product;
provide a second input data set with at least one constraint and at least one further task context;
generate the adapted task graph using a trained neural network based on the first input data set, the second input data set, or the first input data set and the second data set using a reinforcement learning-based approach based on distinct input data sets; and
provide the adapted task graph.

15. (canceled)

16. The computer program product of claim 14, wherein the task graph is a typed task graph.

17. The computer program product of claim 16, wherein the generation of a typed task graph is modeled as an episodic Markov Decision Process.

18. The computer program product of claim 17, wherein one or more trajectories are obtained from the episodic Markov Decision Process, wherein the one or more trajectories include a sequence of triples (<s1, a1, r1>, . . . , <st, at, rt>, . . . , <sT, aT, rT>) where s is a state, a is an action, r is a reward, each at time t until an end of an episode T.

19. The computer program product of claim 18, wherein the reward is given by how well the generated typed task graph matches existing or known examples of valid typed task graphs and by solving or minimizing a number of violated constraints.
